(19) United States
(12) Patent Application Publication
(10) Pub. No.: US 2014/0141824 A1
(43) Pub. Date: May 22, 2014

(54) COMMUNICATING INFORMATION RELATING TO IN-DEVICE COEXISTENCE INTERFERENCE

(71) Applicant: RESEARCH IN MOTION LIMITED, Waterloo (CA)

(72) Inventors: Joon Beom Kim, Carrolton, TX (US); Changhoi Koo, Plano, TX (US); Jun Li, Richardson, TX (US)

(73) Assignee: RESEARCH IN MOTION LIMITED, Waterloo (CA)

(21) Appl. No.: 13/679,011

(22) Filed: Nov. 16, 2012

(51) Int. Cl. H04B 15/00

(52) U.S. Cl. CPC H04B 15/00
USPC 455/501

(57) ABSTRACT

A user equipment calculates a parameter based on a power of in-device coexistence (IDC) interference. The user equipment sends, to a network node, the parameter for use in configuring a threshold relating to the IDC interference.

### BACKGROUND

A user equipment (UE) can include multiple wireless interfaces (e.g. wireless interfaces capable of performing radio frequency (RF) communications). The presence of multiple wireless interfaces allows the UE to communicate content using any of several different communications links. Examples of wireless interfaces that may be present in a UE include a wireless interface to communicate in a Long Term Evolution (LTE) frequency band, a wireless interface to communicate in an Industrial Scientific Medical (ISM) frequency band, or a wireless interface to communicate in a Global Navigation Satellite System (GNSS) frequency band.

### BRIEF DESCRIPTION OF THE DRAWINGS

Some embodiments are described with respect to the following figures.

FIG. 1 is a message flow diagram of a process relating to in-device coexistence (IDC) interference management, in accordance with some implementations.

FIG. 2 is a graph illustrating signal to interference and noise ratio degradation as a function of a ratio equal to IDC interference power divided by a desired signal power.

FIGS. 3-5 are timing diagrams illustrating different IDC interference patterns.

FIG. 6 is a message flow diagram of a static threshold allocation technique, in accordance with some implementations.

FIG. 7 is a message flow diagram of a dynamic threshold allocation technique, in accordance with some implementations.

FIG. 8 is a block diagram of an example arrangement that includes a user equipment and wireless access network nodes, in accordance with some implementations.

FIG. 9 is a block diagram of an example system that incorporates some implementations.

### DETAILED DESCRIPTION

The presence of multiple types of wireless interfaces (that are capable of performing wireless communications according to different wireless technologies) in a user equipment (UE) can result in interference between the different wireless interfaces. In some implementations, the different wireless interfaces may operate concurrently in adjacent or overlapping radio frequency (RF) bands. In the ensuing discussion, a wireless interface that communicates in an RF band is also referred to as a radio interface. Note that although reference is made to radio interfaces in the ensuing discussion, it is noted that techniques or mechanisms can also be applied to other types of wireless interfaces, such as interfaces that communicate at frequencies outside the RF bands, interfaces that communicate optically (e.g. infrared interfaces), interfaces that communicate using acoustic signaling, and so forth.

If multiple radio interfaces in a UE are able to operate concurrently in adjacent or overlapping frequency bands, then signal transmission in a first frequency band by one radio interface in the UE can interfere with signal reception in a second frequency band by another radio interface in the same UE, particularly where the radio interfaces are in relatively close proximity to each other in the UE. Such interference can be referred to as in-device coexistence (IDC) interference. In some examples, IDC interference can occur between a radio interface operating according to the Long Term Evolution (LTE) technology and another radio interface operating according to the Industrial, Scientific and Medical (ISM) technology.

The LTE technology is defined by LTE standards provided by the Third Generation Partnership Project (3GPP). The LTE standards include the initial LTE standards or the LTE-Advanced standards. The LTE standards are also referred to as the Evolved Universal Terrestrial Radio Access (EUTRA) standards.

The frequency band for the ISM technology is reserved for use of certain types of communications, such as Bluetooth communications, WiFi communications, and so forth. The ISM technology is defined by the International Telecommunication Union (ITU).

IDC interference can also exist between an LTE radio interface and another radio interface that performs Global Navigation Satellite Systems (GNSS) communications. An example of a radio interface that performs GNSS communications is a radio interface in a Global Positioning System (GPS) receiver.

Although reference is made to IDC interference between specific example radio interfaces, it is noted that techniques or mechanisms according to some implementations are applicable to address IDC interference between other types of wireless technologies.

In response to detection of IDC interference in a UE that satisfies a triggering condition, the UE can send an IDC indication to a corresponding wireless access network node. In the context of LTE, the wireless access network node can be an enhanced Node B (eNB). Generally, an “IDC indication” includes any information that relates to IDC interference, which can be provided in any of various possible messages that can be sent from a UE to the corresponding wireless access network node.

In some implementations, the triggering condition for triggering transmission of an IDC indication can include a specification of an IDC interference threshold. An IDC interference threshold can refer to a threshold that is used for mitigating (reducing or removing) IDC interference. If IDC interference exceeds the IDC interference threshold, then an IDC indication may be triggered for transmission from the UE to the wireless access network node.

Setting an IDC interference threshold can be challenging. In some cases, a wireless access network node (e.g. eNB) may not have sufficient information to decide what value to use for the IDC interference threshold. Moreover, existing standards do not define the types of information to report from the UE to the wireless access network node for purposes of allocating an IDC interference threshold.

Feedback Parameters for IDC Interference Mitigation

In accordance with some implementations, the UE is able to send certain feedback parameters to a wireless access network node (e.g. eNB) to allow the wireless access network node to use the feedback parameters for setting an IDC interference threshold to be provided to the UE. The IDC interference threshold that can be set by the wireless access network node can be an exact threshold to be used by the UE, or alternatively, the IDC interference threshold can be in the form of a threshold guideline (e.g. a range of thresholds between a minimum threshold and a maximum threshold from which the UE can select, or alternatively, a collection of multiple candidate thresholds).

In some implementations, signal to interference and noise ratio (SINR) measurement techniques can be used for deriving feedback parameters to be sent by the UE to the wireless access network node for the purpose of setting the IDC interference threshold. SINR refers to a value that is computed based on a ratio of signal power to interference power and noise power.

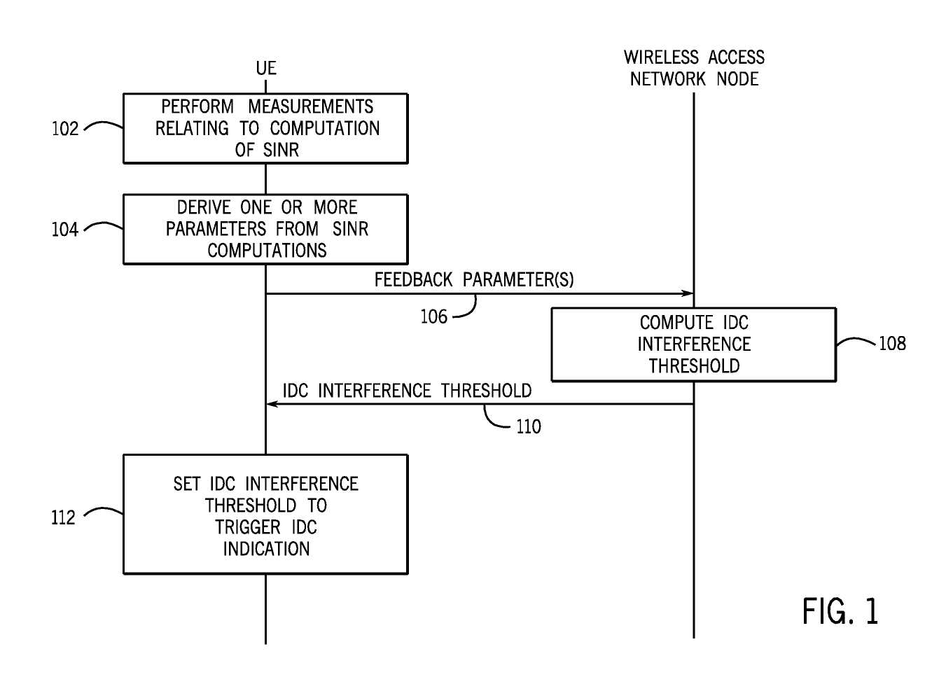

FIG. 1 is a message flow diagram of a process according to some implementations. In FIG. 1, a UE performs (at 102) various measurements relating to computation of SINR. From the measurements, one or more parameters (discussed further below) can be derived (at 104) by the UE. Performing the measurements (102) and computing the parameter(s) (104) can be triggered by the UE, or alternatively, by the wireless access network node sending a request to the UE. The one or more parameters are sent (at 106) as feedback parameters to a wireless access network node. Using the feedback parameter(s), the wireless access network node can compute (at 108) an IDC interference threshold (either an exact threshold or a threshold guideline). A threshold guideline can be a range of thresholds, or a collection of multiple candidate thresholds. The computed IDC interference threshold is then transmitted (at 110) from the wireless access network node to the UE.

The UE can then set (at 112) the IDC interference threshold, based on the IDC interference threshold provided by the wireless access network node, for use in triggering an IDC indication that is to be sent to the wireless access network node. If the IDC interference threshold sent (at 110) is an exact threshold, then the exact threshold can be used by the UE. On the other hand, if the IDC interference threshold sent (at 110) is a threshold guideline, then the UE can set an IDC interference threshold based on the threshold guideline, such as by picking a threshold from a range, or picking a threshold from among a collection of candidate thresholds.

Providing an exact threshold by the wireless access network node allows for network control of the specific IDC interference threshold to be used by the UE, which can be useful for cell load and scheduling control by the network.

In cases where the wireless access network node provides a threshold guideline instead of an exact threshold, the direct control of the specific IDC interference threshold to be used is performed at the UE. However, even in such scenario, the network can still maintain some control over the IDC interference threshold to be used by the UE.

Measurements (102 in FIG. 1) corresponding to two types of SINR computations can be used in accordance with some implementations for deriving feedback parameters. A first SINR computation pertains to SINR with IDC interference (at an LTE radio interface). This is represented as SINR_{IDC} (or T) and is computed as follows:

$${SINR}_{IDC} = T = \frac{{P}_{Desired}}{{\sum }_{i ∈ I} {P}_{Interf , i} + {N}_{T} + {P}_{IDC}} , \qquad ( Eq . 1 )$$

where P_{Desired} is the power of a desired signal (e.g. reference signal) from a serving cell (the cell serving a UE), P_{Inter f,i} is the power of the interference from an interfering cell i after performing receive filtering (receive filtering can refer to filtering of a signal received by a UE by a filter, such as a demodulation filter or another type of filter), N_{T} is the power of the additive noise after performing receive filtering, I is the set of the interfering cells that can interfere with the serving cell, and P_{IDC} is the power of interference signals due to IDC interference on an LTE radio interface. A “desired signal” can refer to a signal that is transmitted by a wireless access network node for receipt by the UE—the desired signal is distinct from interference and noise signals.

In some examples, P_{IDC} can be determined based on measurements at a receiver of a first a radio interface (e.g. LTE radio interface) in the presence of transmissions from a transmitter of another radio interface (e.g. ISM or GNSS radio interface). In alternative implementations, rather than determining P_{IDC} based on measurements, P_{IDC} can be determined based on internal coordination between the radio interfaces of the UE. There can be various operation modes at the UE that can be used to perform IDC interference avoidance or reduction. For example, according to 3GPP TR 36.816, the possible operation modes include an uncoordinated mode, a coordinated within UE only mode, and a coordinated within UE and with network mode. Internal coordination between radio interfaces is possible in the coordinated within UE only mode and the coordinated within UE and with network mode. In the uncoordinated mode, the different radio interfaces within the same UE operate independently without any internal coordination with each other. However, in the coordinated within UE only mode or coordinated within UE and with network mode, there can be internal coordination between the different radio interfaces within the same UE, such that at least the activities of one radio interface is known by the other radio interface. Such coordination allows one radio interface to become aware of presence of IDC interference.

Another SINR computation involves calculating an SINR without IDC interference. This SINR value is represented as SINR_{No IDC} (or X), and can be computed as follows:

$${SINR}_{No IDC} = X = \frac{{P}_{Desired}}{{\sum }_{i ∈ I} {P}_{Interf , i} + {N}_{T}} . \qquad ( Eq . 2 )$$

Note that the computation of SINR_{No IDC} is similar to the computation of SINR_{IDC} except that P_{IDC} is not considered in Eq. 2. The measurement of SINR_{No IDC} is similar to the measurement of a reference signal received quality (RSRQ) without IDC interference on a given LTE subcarrier. RSRQ provides an indication of signal quality, and is based on a ratio of reference signal received power (RSRP) to a carrier received signal strength indicator (RSSI) (which represents received power). RSRP is an average power of a downlink reference signal, such as a Common Reference Signal (CRS), across a frequency bandwidth. More specifically, RSRP is the linear average over the power contributions of resource elements that carry cells that are specific reference signals within the considered measurement frequency bandwidth. RSRQ can be calculated as follows: N×RSRP/(E-UTRA carrier RSSI), where N is the number of radio blocks (RBs) of the E-UTRA carrier RSSI measurement bandwidth. The measurement of RSRQ can be used as an approximation for SINR_{No IDC}.

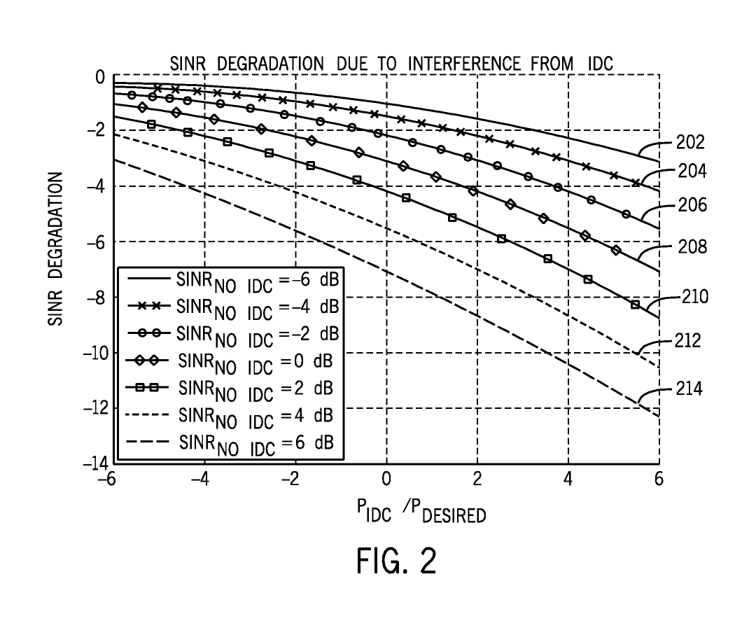

To allow an understanding of why certain feedback parameters can be useful to the wireless access network node in allocating an IDC interference threshold (exact threshold or threshold guideline), reference is made to FIG. 2, which shows SINR degradation (vertical axis of the graph) due to IDC interference. In the example graph of FIG. 2, the horizontal axis represents the ratio of P_{IDC} to P_{Desired}.

The various curves 202, 204, 206, 208, 210, 212, and 214 correspond to different values of SINR_{No IDC}. In the example of FIG. 2, curve 202 corresponds to the lowest SINR_{No IDC} value (e.g. −6 dB), while curve 214 corresponds to the highest SINR_{No IDC} value (e.g. +6 dB). As can be seen in the example graph of FIG. 2, for a larger value of SINR_{No IDC} (such as represented by curve 214), the SINR degradation with IDC interference becomes IDC-dominated as the value of P_{IDC} increases. More specifically, the SINR degradation becomes more dominated by IDC interference (with higher values of P_{IDC}/P_{Desired}) as SINR_{No IDC} increases. Comparing curves 202 and 214, a larger P_{IDC}/P_{Desired} value causes much larger SINR degradation when SINR_{No IDC} is larger (curve 214).

Thus, depending upon the conditions associated with wireless communications between a UE and a wireless access network node, different feedback parameters can be reported from the UE to the wireless access network node. The following discusses some example feedback parameters that can be reported from the UE to the wireless access network node for the purpose of computing an IDC interference threshold at the wireless access network node.

In some implementations, if it is detected from the measurements (at 102 in FIG. 1) that P_{IDC}/P_{Desired} is greater than some specified value, the UE can send an IDC indication instead of sending just feedback parameter(s) (at 106) in FIG. 1. P_{IDC}/P_{Desired} being greater than the specified value can be an indication that the IDC interference is relatively large and should be handled sooner rather than later.

In accordance with some implementations, there are several different feedback parameter solutions relating to reporting of feedback parameters from a UE to a wireless access network node. A first feedback parameter solution can involve reporting feedback parameters based on IDC interference power relative to a power of a desired signal. A second feedback parameter solution can involve reporting feedback parameters based on IDC interference power relative to interference power without IDC plus noise power.

More specifically, the first feedback parameter solution is based on reporting a feedback parameter that is based on the ratio of IDC interference power (P_{IDC}) to the power of the desired signal from a serving cell (P_{Desired}). Such ratio (A) can be computed as follows:

$$A = \frac{{P}_{IDC}}{{P}_{Desired}} . \qquad ( Eq . 3 )$$

Note that the ratio A corresponds to the horizontal axis of the graph of FIG. 2. From Eqs. 2 and 3 above, SINR_{IDC} (SINR with IDC interference) given above in Eq. 1 can be expressed as follows:

T⁻¹=X⁻¹+A. (Eq. 4)

Eq. 4 can be rewritten as

$$T = \frac{X}{1 + AX} . \qquad ( Eq . 5 )$$

T in Eq. 5 represents SINR_{IDC} (SINR with IDC interference).

In the first feedback parameter solution, several options can be used in reporting feedback parameters based on A to the wireless access network node. In a first option, the UE can report A as computed according to Eq. 3. For Eq. 3, the value of P_{IDC} can be determined based on measurement or internal coordination at the UE, while the value of P_{Desired} can be derived based on a measurement of a downlink control signal sent by a wireless access network node to the UE.

The reporting of A can be performed with quantization, which refers to using a dynamically variable number of bits for representing A based on the value of A. In other words, if A has a smaller value, then the number of bits used to represent A can be reduced. This reduces the amount of messaging overhead involved in communicating A.

In a second option of the first feedback parameter solution, the UE can report a differential feedback parameter, represented as R. The reporting of R can also be performed with quantization. R can be defined as follows:

$$R = \frac{{SINR}_{No IDC}}{IDC power / desired signal power} = \frac{X}{A} , \qquad ( Eq . 6 )$$

which can be equivalently written in the dB domain as R_{dB}=X_{dB}−A_{dB}.

In Eq. 6, X is the value given in Eq. 2, and represents SINR without IDC interference. However, since the actual value of X is not available at the wireless access network node, a value can be fed back from the UE to the wireless access network node, from which the wireless access network node can derive A based on R.

In some examples, such a value can be the difference between X and Sⱼ₋₁, where Sⱼ₋₁ defines the lower end of a range specified as follows:

Sⱼ₋₁≦X≦Sⱼ. (Eq. 7)

In the foregoing, Sⱼ₋₁ is the lower end and Sⱼ is the upper end of an SINR range, and X is a value between the two values.

The range end values Sⱼ₋₁ and Sⱼ can be included in entry j of an MCS (modulation and coding scheme) table. The MCS table has multiple entries corresponding to different adaptive MCS schemes that can be used in wireless communications between a UE and a wireless access network node. Example adaptive MCS schemes include Quadrature Phase Shift Keying (QPSK), 16-Quadrature Amplitude Modulator (QAM), 64-QAM, and so forth. In some cases, an MCS scheme can remain constant over several subframes.

Each of the entries of the MCS table has a respective pair of end values Sⱼ₋₁ and Sⱼ that define the respective SINR range. An instance of the MCS table is kept at each of the UE and the wireless access network node. As a result, if provided an index (j) of the MCS table corresponding to the MCS scheme that is used, the UE or wireless access network node would be able to retrieve the corresponding SINR value range specified by Sⱼ₋₁ and Sⱼ.

As noted above, the difference between X and Sⱼ₋₁ is fed back by the UE to the wireless access network node. Since the wireless access network node is aware of the current adaptive MCS scheme used, the wireless access network node can retrieve the corresponding entry of the MCS table to obtain the value of Sⱼ₋₁. Using the retrieved value of Sⱼ₋₁, and the fed back difference between X and Sⱼ₋₁ that has been received from the UE, the wireless access network node can compute X such that the wireless access network node can derive A from the differential feedback parameter R. The value of A can then be used for allocating an IDC interference threshold by the wireless access network node, where this allocated IDC interference threshold is sent to the UE.

Alternatively, to reduce messaging overhead, the difference between X and Sⱼ₋₁ is not sent from the UE to the wireless access network node. Rather, the wireless access network node can use Sⱼ₋₁ retrieved from entry j of the MCS table as an approximation of X, which can be used to determine A based on the differential feedback parameter R of Eq. 6.

Note that the value of Sⱼ₋₁ may depend on the receive filter and the type of receiver. Then, different UEs may have different Sⱼ₋₁ values.

In accordance with some implementations, a feedback reporting threshold β can also be specified. If R≦β, then the differential feedback parameter R is not fed back (at 106 in FIG. 1) to the wireless access network node. R≦β is an indication that IDC interference is large enough such that it may impact system performance. As a result, instead of feeding back R, the UE can instead send an IDC indication. The feedback reporting threshold β may be configurable.

More generally, if a feedback parameter, such as R or A above, has a value with a predefined relationship (greater than or less than) with respect to a feedback reporting threshold, then the feedback parameter is sent by the UE to the wireless access network node. However, if the value of the feedback parameter does not have the predefined relationship with respect to the feedback reporting threshold, then the UE sends an IDC indication instead of the feedback parameter to the wireless access network node.

A third option of the first feedback parameter solution can report an IDC interference threshold as the feedback parameter. Such threshold, represented as P_{Th}, can be computed in one of two ways, as set forth below in Eqs. 8 and 9:

$$\begin{matrix}{P}_{Th} = {SINR}_{IDC} - {SINR}_{No IDC} , & ( Eq . 8 ) \\ {P}_{Th} = \vert {SINR}_{No IDC} - \frac{1}{A} \vert . & ( Eq . 9 )\end{matrix}$$

In Eq. 8, SINR_{IDC} can be computed by the UE using Eq. 5, whereas SINR_{No IDC} can be measured by the UE. In Eq. 9, SINR_{No IDC} is measured, while A is computed according to Eq. 3.

The wireless access network node can use either of the threshold values (according to Eqs. 8 and 9) to derive an IDC interference threshold that can be sent back to the UE. As noted above, the IDC interference threshold that can be provided back to the UE by the wireless access network node can be an exact threshold or a threshold guideline.

Alternatively, as noted above, a second feedback parameter solution for reporting feedback parameters from the UE to the wireless access network node is based on a ratio of IDC interference power relative to interference power without IDC. This ratio can be expressed as follows:

$$B = \frac{{P}_{IDC}}{{\sum }_{i ∈ I} {P}_{Interf , i} + {N}_{T}} . \qquad ( Eq . 10 )$$

Because B=AX, Eq. 10 can be rewritten as follows:

$$T = \frac{X}{1 + B} . \qquad ( Eq . 11 )$$

Note that T represents the SINR with IDC interference (Eq. 1 above). As an alternative, the parameter B in Eq. 10 can be calculated by taking the ratio of the denominator of Eq. 1 to the denominator of Eq. 2 and subtracting unity.

The second feedback parameter solution can also include several options for reporting feedback parameters based on B. In a first option, the UE can report B as calculated according to the Eq. 10, with quantization.

The value of B can be equivalently written in the dB domain as follows:

$${B}_{dB} = {P}_{IDC , dB} - {[ {\sum }_{i ∈ I} {P}_{Interf , i} + {N}_{T} ]}_{dB} . \qquad ( Eq . 12 )$$

In some examples, the UE can additionally feed back the value of P_{IDC} to the wireless access network node either directly or as a differential value.

Alternatively, in a second option of the second feedback parameter solution, the UE can report an IDC interference threshold, represented as P_{Th}, which can be calculated as follows:

P_{Th}=SINR_{IDC}−SINR_{NO IDC}, (Eq. 13)

B≧P_{Th}. (Eq. 14)

According to Eq. 13, the threshold (P_{Th}) is represented as the difference between the SINR with IDC interference (SINR_{IDC}) and the SINR without IDC (SINR_{No IDC}).

Alternatively, instead of reporting the threshold as P_{Th} according to Eq. 13, the parameter B (Eq. 10) is reported if B≧P_{Th}.

In response to any of the feedback parameters discussed above that are sent by the UE to the wireless access network node, the wireless access network node can allocate an IDC interference threshold (exact threshold or threshold guideline) that is sent to the UE, which can then set its IDC interference threshold accordingly.

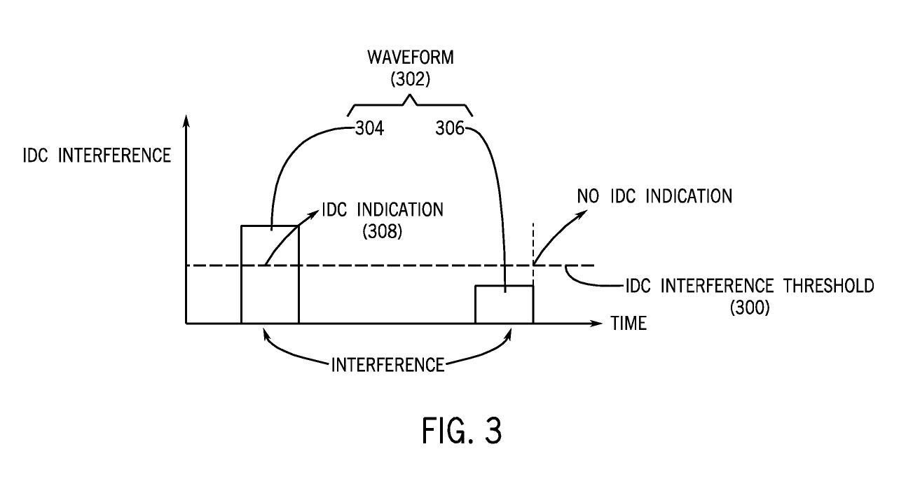

FIG. 3 is a timing diagram that illustrates IDC interference at an LTE receiver due to transmission of signals by a transmitter (e.g. a WiFi transmitter) in the same UE. The vertical axis in the graph of FIG. 3 represents IDC interference at the LTE receiver, and the horizontal axis represents time. FIG. 3 shows how an IDC interference threshold 300 can be used for triggering an IDC indication in accordance with some implementations. The IDC interference threshold 300 is represented by a dashed horizontal line.

A time-varying waveform 302 represents IDC interference caused by a dynamically fluctuating traffic pattern of the WiFi transmitter. If the IDC interference at the LTE receiver is detected to exceed the interference threshold 300, then an IDC indication can be triggered.

A first block 304 of the waveform 302 represents the magnitude and duration of IDC interference caused by first transmitted traffic from the WiFi transmitter, while a second block 306 represents the magnitude and duration of IDC interference caused by second transmitted traffic from the WiFi transmitter.

In the example of FIG. 3, the IDC interference represented by the block 304 causes an IDC indication (308) to be transmitted by the UE, where the IDC indication indicates presence of IDC interference at the UE. On the other hand, the IDC interference represented by the block 306 has a magnitude that is less than the IDC interference threshold 300, which leads to the UE not sending an IDC indication, or alternatively, an IDC indication that indicates there is no IDC interference at the UE.

A wireless access network node can send an IDC solution to the UE in response to an IDC indication from the UE that indicates presence of IDC interference. The IDC solution causes the UE to modify its wireless communication behavior to remove or reduce the IDC interference. In some examples, the wireless access network node can select one of several IDC solutions to allocate to the UE in response to an IDC indication. As examples, the IDC solutions can include a Frequency Division Multiplexing (FDM) solution or a Time Division Multiplexing (TDM) solution. As other examples, the IDC solutions can further include a power control solution.

An FDM solution generally involves modifying the communication frequency of a particular radio interface in the UE to cause frequency separation between transmissions at a first radio interface and receptions at a second radio interface. Modifying the communication frequency of the particular radio interface can be accomplished by performing handover of a communications session of the particular radio interface from a first radio carrier (at a first frequency) to a second radio carrier (at a second, different frequency).

In some examples, to implement the FDM solution, the UE can inform the wireless access network node when transmission/reception of LTE or other radio signals would benefit or no longer benefit from the LTE radio interface of the UE not using certain carriers or frequency resources. With this approach, the UE indicates which frequency or frequencies are (or are not) useable due to IDC interference. The indication of which frequency or frequencies are (or are not) useable can be communicated in an IDC indication sent by the UE. The IDC indication sent by the UE to the wireless access network node can also include various frequency measurement information that can also be used by the wireless access network node to decide on the FDM solution to use.

A TDM solution generally involves modifying a time pattern associated with communication of a particular radio interface in the UE to cause time separation between transmissions at a first radio interface and receptions at a second radio interface. There can be several types of TDM solutions, including, as examples, the following: a TDM-DRX (Discontinuous Reception) solution, a TDM-HARQ (Hybrid Automatic Repeat Request) solution, and a TDM-gap solution.

With a TDM solution, the UE can send information regarding the IDC interference in an IDC indication, where the information can include the following example information: interferer type, mode, and appropriate offset in subframes. Based on the information, the wireless access network node can configure a TDM pattern for the TDM solution, where the TDM pattern specifies scheduling and unscheduled periods for communication of the UE. In some examples, the UE can suggest a TDM pattern in the IDC indication. In response to the suggested TDM pattern from the UE, the wireless access network node can decide on the final TDM pattern to use.

With a TDM-DRX solution, the UE can provide the wireless access network node with a desired TDM pattern. For example, the parameters related to the TDM pattern can include the following: (1) the periodicity of the TDM pattern, and (2) the scheduling period (or unscheduled period). It is up to the wireless access network node to decide and signal the final DRX configuration to the UE based on the UE suggested TDM pattern and other possible criteria (e.g. traffic type). The scheduling period corresponds to the active time of DRX operation, while unscheduled period corresponds to the inactive time.

With a TDM-HARQ solution, a number of LTE HARQ processes are reserved for LTE operation, and the remaining subframes are used to accommodate non-LTE (e.g. ISM or GNSS) traffic.

With the TDM-gap solution, the “gap” refers to a period during which the UE can perform measurements to obtain frequency measurement information (discussed further below) relating to the LTE radio interface in the UE. During each such gap, no uplink or downlink transmissions are scheduled. During the gap, the non-LTE radio interface can transmit and receive data.

A power control solution can be used to reduce power reduction at the UE to mitigate IDC interference. In some examples, the UE can report to the wireless access network node that power reduction is desired. In response, the wireless access network node can adjust the UE transmission power at one or more of the radio interfaces in the wireless access network node.

Although various IDC solutions are described above, it is noted that other IDC solutions can be used in other implementations.

Eq. 2 discussed above provides an example of how an SINR value without IDC interference can be computed. However, the computation of an SINR value without IDC interference can differ depending on which of the following antenna arrangements are used: SIMO (single-input multiple-output), SFBC (space-frequency block code), and MIMO (multiple-input multiple-output). The foregoing arrangements can be used with maximum ratio combining (MRC) or minimum mean-squared estimation (MMSE). MRC is a first receiver type that provides a diversity combining technique in which signals from multiple channels are combined. MMSE is another receiver type that provides for channel estimation.

For 2×2 wireless channels, MRC for SIMO or SFBC, and MMSE for MIMO are considered below. The computations can be extended to N×M wireless channels.

A wireless channel with two transmit and two receive antennas can be represented as follows:

$$H = [ \begin{matrix}{h}_{11} & {h}_{12} \\ {h}_{21} & {h}_{22}\end{matrix} ] \qquad ( Eq . 15 )$$

where h₁₁ is the channel associated with the j^{th} transmit and i^{th} receive antenna pair.

For SIMO and SFBC, the SINR for a subcarrier can be given by

$${SINR}_{No IDC} = {\sum }_{i = 1}^{2} \frac{{\sum }_{j = 1}^{2} {\vert {h}_{ij}^{serv} \vert}^{2}}{{\sum }_{j = 1}^{2} ( {\vert {h}_{ij}^{serv} \vert}^{2} \times {I}_{j} )} \qquad ( Fig . 16 )$$

where

$${I}_{j} = {\sum }_{j ∈ ϑ} {\sum }_{i = 1}^{2} {\vert {h}_{ij}^{Interf} \vert}^{2} + {N}_{0} ,$$

and υ is the set of the interfering cells. The value of Iⱼ may be estimated from the interfering cells.

For MIMO with MMSE detector, the SINR of the i^{th} layer at a subcarrier can be given by:

$${SINR}_{No IDC}^{ith layer} = \frac{{( {\sum }_{j = 1}^{2} {W}_{ij} {h}_{ij}^{serv} )}^{2}}{{\sum }_{j = 1}^{2} ( {\vert {W}_{ij} \vert}^{2} \times {I}_{j} ) + {\sum }_{l = 1 , l \neq i}^{2} {( {\sum }_{j = 1}^{2} {W}_{ij} {h}_{lj} )}^{2}} \qquad ( Eq . 17 )$$

where Wᵢⱼ is the i^{th} row and j^{th} column of the MMSE matrix W=(H^{H}H+NₒI)⁻¹H^{H}, and N₀ is the additive white Gaussian noise. Note that other receiver types can be similarly applied.

SNR Reporting For Different Traffic Patterns

The pattern of traffic of a non-LTE radio interface that can interfere with the LTE radio interface of a UE can either be a uniform traffic pattern or a non-uniform traffic pattern. The uniform or non-uniform traffic pattern can correspond to the traffic pattern of an ISM radio interface, a GNSS interface, or any other interface that can cause IDC interference with the LTE radio interface of the UE.

Although reference is made to uniform or non-uniform traffic patterns that can interfere with the LTE radio interface, note that a traffic pattern transmitted from the LTE radio interface can also have uniform or non-uniform traffic patterns that can cause IDC interference with another radio interface in the same UE, such as the ISM radio interface or the GNSS radio interface.

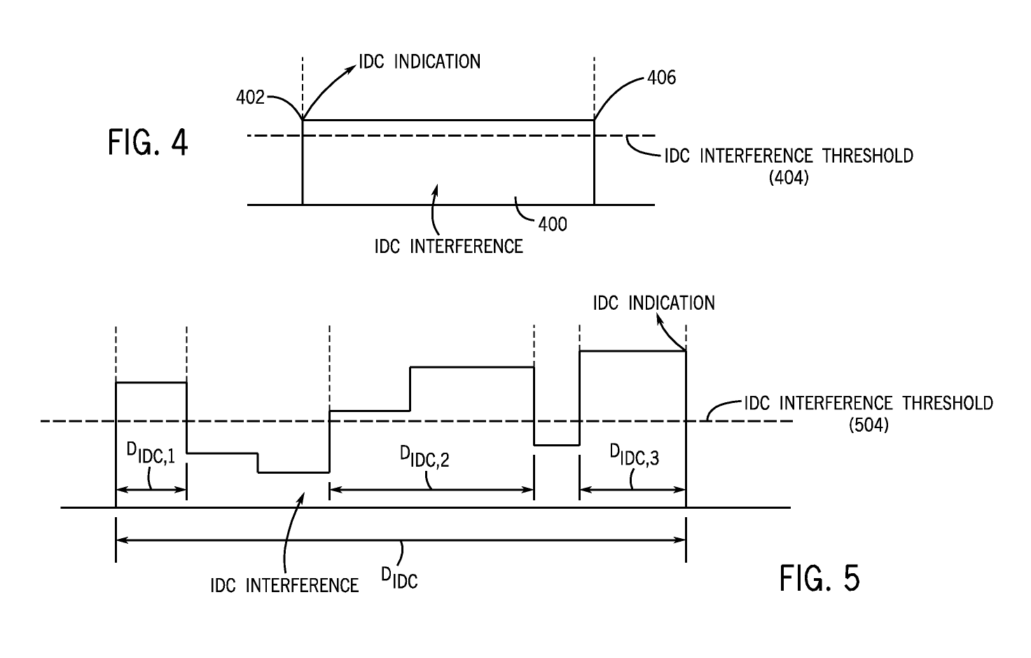

As shown in FIG. 4, when the interfering traffic (the traffic that causes IDC interference with the LTE radio interface) can be considered uniform, the UE can send an IDC indication at the start of any detected or predicted IDC interference without considering traffic pattern variation. As depicted in FIG. 4, the IDC interference represented by block 400 (due to a uniform traffic pattern) has a magnitude that exceeds an IDC interference threshold 404. Consequently, an IDC indication can be sent at 402 at the start of the IDC interference that is detected or predicted to exceed the IDC interference threshold 404.

A UE is able to predict that an interfering traffic pattern will be uniform since the UE knows the data that is being sent by the interfering radio interface. Since the interference is coming from a different radio interface within the same UE, the IDC interference level can be characterized for subsequent use rather than having to measure the IDC interference level at the time that data is being transmitted by the LTE radio interface.

In some implementations, during a time that the IDC interference level exceeds the IDC interference threshold 404, the UE can repeatedly send an IDC indication on an intermittent basis or on a regular basis (such as based on expiration of a timer in the UE). In FIG. 4, the UE can send an IDC indication (to indicate interference is present) at the starting point 402 of the IDC interference that exceeds the IDC interference threshold 404. Additionally, the UE can send another IDC indication at the end (406) of the block 400, to indicate that no further IDC interference will be present. In some examples, no other IDC indication has to be sent at points between the beginning (402) and the end (406) of the block 400, which reduces messaging overhead.

In some examples, the IDC interference threshold used at the UE can be represented as P_{Th}, and a comparison can be made between A (Eq. 3 above) and P_{Th}. If A is greater than or equal to P_{Th}, then the UE sends the IDC indication (for indicating presence of IDC interference) to the wireless access network node.

In some examples, the IDC interference threshold P_{Th} can be maintained constant for the duration of the uniform interfering traffic pattern.

In alternative examples, the IDC interference threshold P_{Th} can vary with the adaptive MCS (modulation and coding scheme) used by the UE. For example, a first value of P_{Th} can be used if a first MCS scheme is used, a second, different value of P_{Th} is used if a second, different MCS scheme is used, and so forth. Thus, as the adaptive MCS scheme varies due to varying wireless channel conditions, the IDC interference threshold P_{Th} can vary accordingly.

In the foregoing discussion, it can be assumed that the SINRs with and without IDC (as represented by SINR_{IDC} and SINR_{No IDC}, respectively) are constant in the presence of the uniform interference traffic pattern. However, in some cases, the SINR with IDC and the SINR without IDC can vary (constructively or destructively) as a function of time, due to time selectivity of wireless channels, even though the IDC interference is uniform. The wireless channels used for communications between a UE and a wireless access network node can be time varying during measurements pertaining to IDC interference. For example, variation can be due to the value of desired signal power P_{Desired} and the value of the noise power N_{T} fluctuating due to the time selectivity of the wireless channels.

In the presence of such fluctuation, IDC indications may be sent too frequently by a UE, which can result in excessive messaging overhead, including excessive amounts of higher layer signaling. To resolve this issue, the determination of whether IDC interference exceeds an IDC interference threshold occurs in time intervals that exclude those time durations due to time selectivity of wireless channels, which can be caused by motion of the UE, for example.

In further examples, a time averaging window approach can be used for computing an average of SINR_{No IDC} values. Due to time selectivity of wireless channels, SINR_{No IDC} may vary. The time averaging window approach defines a time window in which multiple different SINR_{No IDC} values can be averaged to obtain an average SINR_{No IDC} value. For enhanced accuracy, time periods due to time selectivity of wireless channels can be excluded from the time averaging window for the purpose of determining the average SINR_{No IDC} value.

The foregoing has discussed IDC interference caused by uniform traffic patterns. FIG. 5 depicts an example of IDC interference caused by a non-uniform traffic pattern. For the purpose of determining whether or not an IDC indication should be sent to indicate presence of IDC interference in the presence of a non-uniform traffic pattern, various parameters are used. Such parameters are used for the purpose of determining whether or not a detected IDC interference exceeds the IDC interference threshold (504 in FIG. 5) for a sufficiently long period of time.

In some examples, the parameters used for triggering the sending of an IDC indication are listed below (in other examples, other parameters can be used):
reference time duration (D_{IDC}),
a fraction of the reference time duration (a),
threshold (P_{Th}).

FIG. 5 shows the reference time duration (D_{IDC}), which defines a time duration over which an interference level is to be measured for comparison with the IDC interference threshold 504, which is represented by P_{Th}. The parameter a can be a specified constant value that is to be multiplied by D_{IDC} for defining a threshold time duration. If the IDC interference exceeds the IDC interference threshold 504 for an amount of time that is greater than or equal to the threshold time duration, then an IDC indication is triggered, as discussed further below.

The foregoing parameters can be configurable by the wireless access network node and signaled to the UEs so that all UEs employ consistent triggering parameters for triggering IDC indications. Alternatively, a particular UE can configure the parameters and signal them to the wireless access network node for cases where the particular UE can better predict the interference pattern because the particular UE is in control of sending the interfering signal. In any case, these parameters can be agreed to in advance between the UE and the wireless access network node.

Based on the above parameters, the UE measures the time duration out of the reference time duration (D_{IDC}) when the IDC interference exceeds the IDC interference threshold (A≧P_{Tn}), where A is computed according to Eq. 3 above. The measured time duration is compared with the value α·D_{IDC}, which represents the threshold time duration noted above. When the measured time duration exceeds α·D_{IDC}, the UE sends an IDC indication message to the wireless access network node.

In the example of FIG. 5, D_{IDC,1}, D_{IDC,2} and D_{IDC,3}, are respective measured time durations during which the respective IDC interference exceeds the IDC interference threshold 504. In the example of FIG. 5, if D_{IDC,1}+D_{IDC,2}+D_{IDC,3}≧α·D_{IDC}, then the UE sends an IDC indication to the wireless access network node. It is noted that if D_{IDC,1}+D_{IDC,2}≧α·D_{IDC}, then the UE can trigger the sending of the IDC indication without having to wait for the end of the third time duration D_{IDC,3}. In other words, the UE is able to trigger the sending of an IDC indication upon detecting that an aggregate time duration during which the IDC interference exceeds the IDC interference threshold exceeds α·D_{IDC}.

In some implementations, an additional timer can be provided to initiate the IDC calculation from a higher layer in the UE (where a higher layer is a layer above the physical layer). It is assumed that the determination of whether IDC interference exceeds an IDC interference threshold, or a measured time duration when IDC interference exceeds a threshold time duration, can be performed at the physical layer of the UE. The additional timer in the higher layer can be used to trigger the IDC calculations for determining whether or not the IDC interference should trigger the sending of an IDC indication. The timer value for the additional timer can be preconfigured in the UE, or can be configured by a wireless access network node.

Similar to the uniform interfering traffic pattern scenario, the SINR with IDC interference and the SINR without IDC interference may vary either constructively or destructively as a function of time, due to the time selectivity of wireless channels, even though the IDC interference is uniform. The wireless channels used for communications between a UE and a wireless access network node can be time varying during measurements pertaining to IDC interference. For example, variation can be due to the value of desired signal power P_{Desired} and the value of the noise power N_{T} fluctuating due to the time selectivity of the wireless channels. In the presence of such fluctuation, IDC indications may be sent too frequently by a UE, which can result in excessive messaging overhead, including excessive amounts of higher layer signaling. To resolve this issue, the determination of time durations during which IDC interference due to the non-uniform interfering traffic pattern exceeds the IDC interference threshold may exclude the time durations due to time selectivity of wireless channels.

In-Device Co-Existence (IDC) Interference Assistance Information

The various feedback parameters discussed above can be sent as IDC interference assistance information to a wireless access network node. In addition to the foregoing feedback parameters, additional IDC interference assistance information can be sent by the UE to the wireless access network node, including any or some combination of the following:
at least one characteristic regarding a non-LTE radio interface that causes the IDC interference, where the at least one characteristic can include a transmission power of the non-LTE radio interface, a spurious power of the non-LTE radio interface, an out-of-band emission power of the non-LTE radio interface, and so forth;
information regarding a type of application or a type of traffic pattern (e.g. constant bit rate (CBR) traffic pattern, variable bit rate (VBR) traffic pattern, and so forth) (this information can be derived using internal coordination between the radio interfaces of the UE);
an observed IDC interference pattern (such as the uniform or non-uniform interference pattern depicted in FIG. 4 or 5);
statistics regarding an error rate of a downlink from the wireless access network node to the UE;
a receiver type (e.g. maximum ratio combining (MRC) receiver, minimum mean-squared estimation (MMSE) receiver, etc.);
a reference time duration (D_{IDC} discussed above);
a fraction of the reference time duration (a as discussed above); and
an IDC interference threshold (which can be an exact threshold or a threshold guideline).

More generally, the assistance information that can be sent by the UE to the wireless access network node includes parameters that relate to setting an IDC interference threshold.

Several options can be employed for the UE to send IDC interference assistance information to the wireless access network node.

According to option 1, the UE sends the IDC interference assistance information upon request by the wireless access network node.

According to option 2, the UE sends the IDC interference assistance information periodically, based on a specified time interval. The wireless access network node may configure the specified time interval.

According to option 3, the UE sends the IDC interference assistance information in response to a specified event. Examples of specified events can include an event indicating an error rate increase, an event indicating a change in the IDC interference by greater than some specified amount, and so forth. According to option 3, the wireless access network node can request the IDC interference assistance information from the UE when the wireless access network node detects any of the specified events. Alternatively, the UE can send the IDC interference assistance information when the UE detects any of the specified events.

According to option 4, the wireless access network node can preconfigure at least one triggering parameter (as a system parameter) that controls the UE sending a first IDC indication that contains the IDC interference assistance information. The UE performs the first transmission of the IDC indication based the at least one preconfigured triggering parameter. Thereafter, the UE can request, at any time, a change of the at least one preconfigured triggering parameter, based on a traffic status of the UE, for example.

According to option 5, a hybrid approach that uses multiple ones of the options listed above can be used.

Although five example options are listed above that specify respective triggers for triggering the sending of the IDC interference assistance information, it is noted that, in other implementations, additional or alternative options can be employed for triggering of the sending of the IDC interference assistance information.

In accordance with some examples, the wireless access network node can send control information according to Table 1 or 2 below to specify the option(s) to use for sending IDC interference assistance information by the UE. Although specific examples of the control information are depicted in Tables 1 and 2, it is noted that different forms of the control information can be used in other examples.

TABLE 1
Assistance information control
information

| | |
|---|---|
| Option 1 | 000 |
| Option 2 | 001 |
| Option 3 | 010 |
| Option 4 | 011 |
| Option 5 | 100 |
| Reserved | 111 |

In Table 1, the control information can be in the form of a bitmap, such as a bitmap of three bits. The bitmap can be set to one of several different values in the example Table 1, where a value of “000” indicates that option 1 is to be used, a value of “001” indicates that option 2 is to be used, a value of “010” indicates that option 3 is to be used, a value of “011” indicates that option 4 is to be used, and a value of “100” indicates that option 5 is to be used. A value of “111” for the bitmap is indicated as reserved in the foregoing example.

Table 2 below indicates alternative control information to use for indicating the approach to use for triggering the sending of the IDC interference assistance information from the UE to the wireless access network node.

TABLE 2
Assistance information control information

| | | |
|---|---|---|
| Option 1 | 0 or 1 | If the bit is set to “1”, option 1 will be |
| | | enabled, otherwise, option 1 will not |
| | | be enabled |
| Option 2 | 0 or 1 | If the bit is set to “1”, option 2 will be |
| | | enabled, otherwise, option 2 will not |
| | | be enabled |
| Time Period | 000 | If the “Option 2” bit is set to “1”, this |
| | | field is set to a reporting time interval. |
| Option 3 | 0 or 1 | If the bit is set to “1”, option 3 will be |
| | | enabled; otherwise, option 3 will not |
| | | be enabled. |
| Option 4 | 0 or 1 | If the bit is set to “1”, option 4 will be |
| | | enabled; otherwise, this option will |
| | | not be enabled. |

Each row of Table 2 corresponds to a different field that is settable to one of multiple values. For example, the first row has a bit that is settable between “0” and “1” to indicate whether or not triggering of sending of IDC interference assistance information by the UE can be based on a request by the network node (option 1 above). Similarly, the second, fourth, and fifth rows of Table 2 specify whether or not the respective options 2, 3, and 4, are to be enabled. If option 2 is enabled (the periodic option), then the third row of Table 2 specifies the reporting time interval for periodically sending the IDC interference assistance information. The unit of time for the reporting time interval can be actual time, number of subframes, and so forth.

With the Table 2 control information, multiple options can be enabled, which would provide the hybrid approach of option 5.

The control information for controlling the reporting of IDC interference assistance information by the UE (such as the control information of Table 1 or 2) can be sent by the wireless access network node to the UE using any of the following messages:
the wireless access network node capability indication message, which indicates the capability of the wireless access network node with respect to a solution that can be provided by the wireless access network node for IDC interference;
a new information element of an existing Radio Resource Control (RRC) message;
a new RRC message;
an IDC indication response message (which is sent in response to an IDC indication message from the UE for indicating whether or not there is IDC interference at the UE).

In the foregoing, an “existing” message or information element refers to a message or information element that is defined by an existing version of a wireless access technology standard, such as the LTE standard. A “new” message or information element refers to a message or information element that is not defined by an existing version of a wireless access technology standard, but may be incorporated into a later version of the wireless access technology standard.

The control information of Table 1 or 2 can be updated upon request by the UE. For example, the IDC indication message that is sent by the UE upon the UE detecting IDC interference can include an update request of the control information in Table 1 or 2.

Alternatively, the wireless access network node can update the control information of Table 1 or 2, such as in response to changing conditions detected by the wireless access network node. For example, if the UE has relatively constant IDC interference, certain parameters related to the IDC interference threshold setting can be used without significant change, so that the UE can send the IDC interference assistance information discussed above less frequently. However, if the UE has irregular traffic, such as non-uniform traffic, some of the parameters may have to be adjusted more frequently to account for the variation, so that the UE should send the IDC interference assistance information more frequently.

Table 3 below depicts various example techniques of setting an IDC interference threshold by the wireless access network node. In some examples, the UE can send IDC interference threshold information in addition to, or as part of, the IDC interference assistance information noted above. The wireless access network node can use the IDC interference threshold information from the UE, along with the assistance information, to compute an IDC interference threshold (exact threshold or threshold guideline).

TABLE 3
Possible threshold settings

| | UE | Wireless Access Network Node |
|---|---|---|
| Option 1 | Send threshold guideline | Allocate threshold guideline |
| Option 2 | Send threshold guideline | Allocate exact threshold |
| Option 3 | Send exact threshold | Allocate threshold guideline |
| Option 4 | Send exact threshold | Allocate exact threshold |

In the foregoing example, Table 3 above lists four threshold setting options. According to threshold setting option 1, the UE can send a threshold guideline to the wireless access network node, which can allocate a threshold guideline based on information reported from the UE, including the threshold guideline from the UE and the IDC interference assistance information.

The threshold guideline allocated by the wireless access network node may be the same as or different from the threshold guideline provided by the UE. Upon receiving the allocated threshold guideline from the wireless access network node, the UE may set its own IDC interference threshold based on the allocated threshold guideline from the wireless access network node.

In threshold setting option 2 of Table 3, the UE can send a threshold guideline to the wireless access network node, and the wireless access network node can allocate an exact IDC interference threshold based on the threshold guideline from the UE and based on the assistance information. Upon receiving the exact IDC interference threshold from the wireless access network node, the UE can use the exact IDC interference threshold for triggering the sending of an IDC indication.

According to threshold setting option 3 in Table 3, the UE sends an exact IDC interference threshold to the wireless access network node, and the wireless access network node allocates a threshold guideline based on the information received from the UE, including the exact IDC interference threshold and the assistance information. When the UE receives the threshold guideline from the wireless access network node, the UE can set its own IDC interference threshold based on the threshold guideline from the wireless access network node.

According to threshold setting option 4 in Table 3, the UE sends an exact IDC interference threshold to the wireless access network node, and the wireless access network node allocates an exact IDC interference threshold based on the information received from the UE, including the exact IDC interference threshold from the UE and the assistance information. The exact IDC interference threshold allocated by the wireless access network node can be the same as or different from the exact IDC interference threshold provided by the UE. When a UE receives the allocated exact IDC interference threshold from the wireless access network node, the UE uses the exact IDC interference threshold for triggering the sending of an IDC indication.

Threshold Allocation Techniques

There are two possible techniques for allocating an IDC interference threshold for use by the UE. A first allocation technique is a static allocation technique, where the IDC interference threshold used by the UE is not changed during a particular IDC session associated with traffic that causes the IDC interference. A second allocation technique is a dynamic allocation technique, where the IDC interference threshold used by the UE can be changed during the IDC session. An IDC session associated with traffic that causes the IDC interference can start when an application begins an operation that involves the sending of the traffic, and can end when the application stops the operation. Alternatively, the IDC session can start upon detection of the traffic, and can stop when the traffic is detected to have stopped.

With the static allocation technique, signaling associated with the sending of threshold information and assistance information from the UE to the wireless access network node, and the sending of an allocated threshold from the wireless access network node to the UE, can be reduced, which reduces messaging overhead over the wireless link.

Several types of uplink messages can be used to carry the IDC interference assistance information from the UE to the wireless access network node, including the following example uplink messages:
a UE capability message (which identifies a capability of the UE with respect to IDC interference, such as whether the UE can support both a TDM and an FDM solution);
a new information element of an existing RRC message;
a new RRC message;
an IDC indication message;
control signaling in a physical uplink control channel (PUCCH).

The allocated threshold information (exact threshold or threshold guideline) can be sent by the wireless access network node to the UE using any of the following example downlink messages:
a new RRC message;
a new information element of an existing RRC message;
a new medium access control (MAC) control element (CE);
a reserved field of an existing MAC CE; and
an IDC response message (which is a response to the IDC indication).

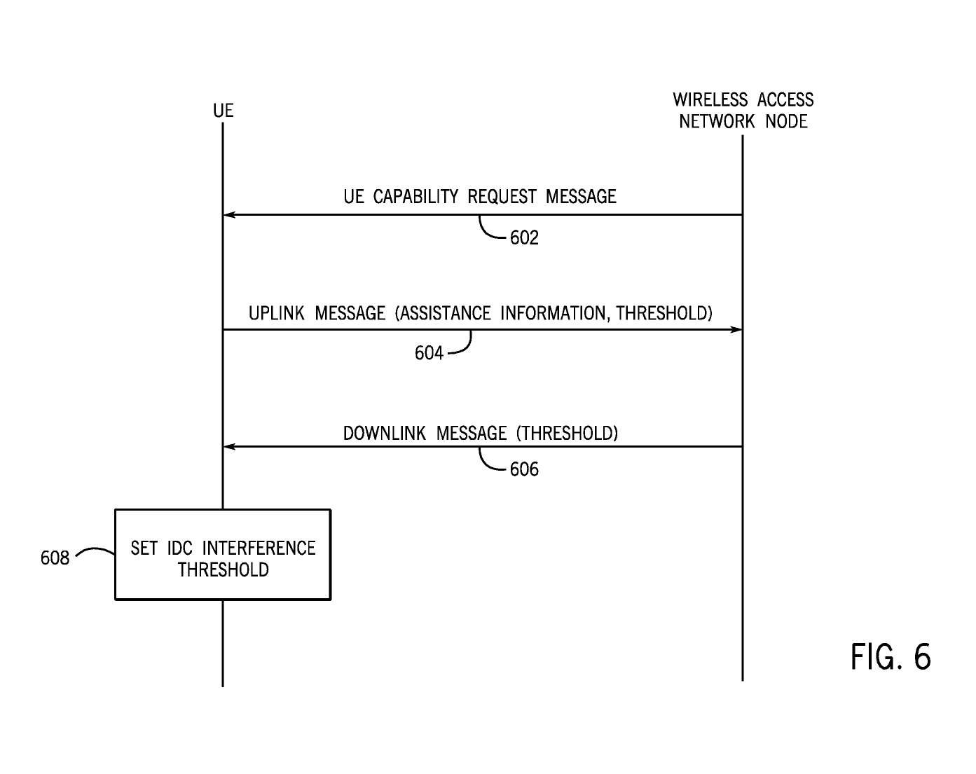

FIG. 6 is a message flow diagram relating to the static allocation technique discussed above. The wireless access network node sends (at 602) a UE capability request message to the UE. The UE capability request message is a message seeking certain information associated with the UE.

In response to the UE capability request message, the UE sends (at 604) an uplink message that includes the IDC interference assistance information. The uplink message can be any of the uplink messages identified above, or some other uplink message. Additionally, or alternatively, the uplink message can also carry an IDC interference threshold, which can be either a threshold guideline or an exact threshold as noted in Table 3 above, for example.

In response to the uplink message, the wireless access network node sends (at 606) a downlink message that contains an allocated IDC interference threshold, which can be an exact threshold or a threshold guideline as noted in Table 3 above, for example. The downlink message can be any of the downlink messages noted above, or some other downlink message.

In response to the allocated IDC interference threshold in the downlink message, the UE sets (at 608) the IDC interference threshold to be used by the UE.

As noted above, a threshold guideline that is sent by the wireless access network node can include a range defined by an upper threshold value and a lower threshold value. In such an approach, the wireless access network node provides two threshold values to the UE in the downlink message sent at 606, where the two threshold values define the threshold range.

Alternatively, a threshold guideline sent by the wireless access network node in the downlink message at 606 can include one threshold value P_{Th}, along with a delta value A. The threshold range can then be defined as P_{Th}±Δ.

Similar techniques can be used for reporting a threshold guideline from a UE to a wireless access network node.

With the static allocation technique of FIG. 6, the threshold information provided by the wireless access network node is not changed or updated during an IDC session.

The dynamic allocation technique can dynamically change the IDC interference threshold provided by the wireless access network node during an IDC session, which can be based on request by the UE or based on a determination by the wireless access network node, or both. The dynamic threshold is changeable by one or both of the UE and wireless access network node at any time during the IDC session. For example, a UE may request a change of the allocated threshold based on a change in the traffic pattern of the non-LTE radio interface that is causing the IDC interference. Alternatively, the wireless access network node can change the allocated threshold due to changing conditions associated with scheduling or load balancing.

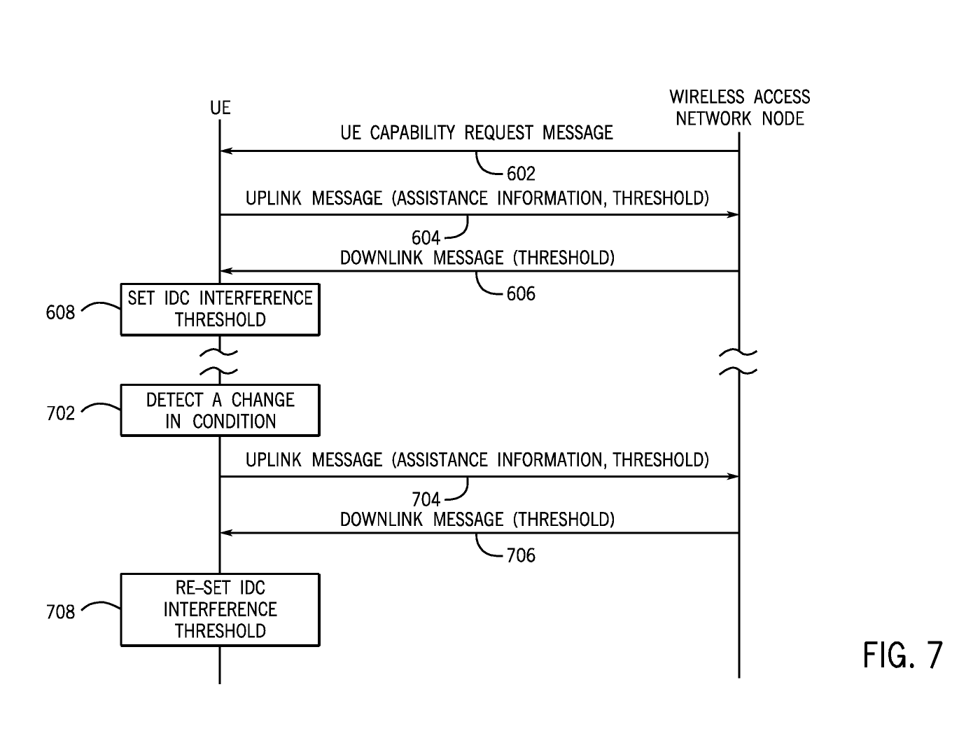

FIG. 7 depicts a message flow diagram of a process of the dynamic allocation technique, in accordance with some examples. Tasks 602, 604, 606, and 608 are the same as corresponding tasks in FIG. 6, and thus, are not discussed further.

According to FIG. 7, after the UE has set the IDC interference threshold to use (at 608), the UE detects (at 702) a change in condition that would warrant a change in the IDC interference threshold. In response to detecting the change in condition, the UE sends (at 704) an uplink message to request the re-configuring of the IDC interference threshold. The uplink message sent at 704 can carry IDC interference assistance information, or a UE-provided IDC interference threshold (exact threshold or threshold guideline), or both.

In response to the uplink message sent at 704, the wireless access network node sends (at 706) a downlink message that contains the changed allocated IDC interference threshold, which can be an exact threshold or a threshold guideline. In response to the downlink message sent at 706, the UE re-sets (at 708) its IDC interference threshold.

In the example process of FIG. 7, the uplink messages (sent at 604, 704) and the downlink messages (sent at 606, 706) can be any of the uplink and downlink messages, respectively, listed further above, or other uplink and downlink messages.

The selective use of the static allocation technique or the dynamic allocation technique for setting the IDC interference threshold can depend on the UE's traffic status and the wireless access network node's scheduling and load balancing status. In accordance with some implementations, either the UE or the wireless access network node, or both, can request a change between the static and dynamic allocation techniques. For example, an information field (e.g. one bit or multiple bits) can be used for indicating whether the static of dynamic allocation technique is to be used. If the information field has a first value, then the static allocation technique is used. On the other hand, if the information field has a second value, then the dynamic allocation technique is used.

The information field for controlling which of the static or dynamic allocation technique to be used can be carried in any of the following messages:
a new RRC message;
a new information element of an existing RRC message;
an IDC indication response message;
a reserved field in an existing MAC CE; and
a new MAC CE.

System Architecture

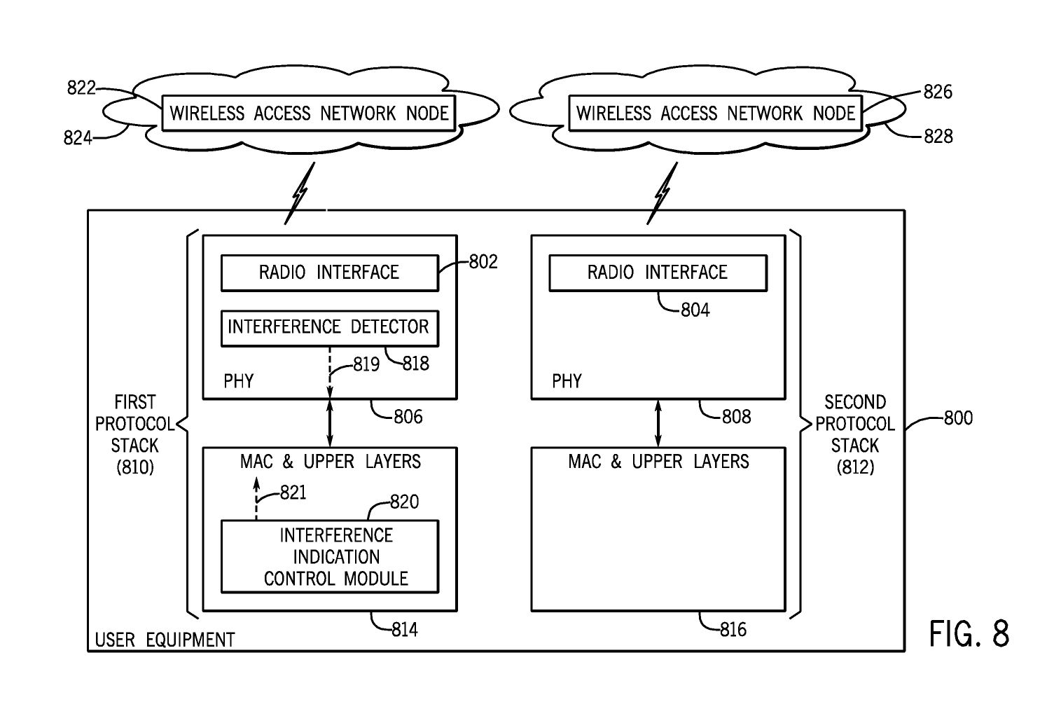

FIG. 8 is a block diagram of an example arrangement that includes a UE 800, which can be a mobile telephone, a smartphone, a personal digital assistant (PDA), a tablet computer, a notebook computer, or any other type of electronic device that is capable of performing wireless communications. In the example of FIG. 8, the UE 800 can include two different types of radio interfaces 802 and 804 that operate according to corresponding different wireless technologies. Although just two radio interfaces 802, 804 are depicted in FIG. 8, it is noted that in alternative examples, there can be more than two different types of radio interfaces in the UE 800.

The radio interface 802 is able to wirelessly communicate with a wireless access network node 822 in a wireless access network 824, and the radio interface 804 is able to wirelessly communicate with another wireless access network node 826 in a wireless access network 828. Each radio interface 802 or 804 can be a radio transceiver that includes a transmitter to transmit RF signals, and a receiver to receive RF signals.

The radio interfaces 802 and 804 are part of respective protocol stacks 810 and 812. The first and second protocol stacks 810 and 812 form a communication subsystem of the UE 800, to allow the UE 800 to communicate with various external entities.

The first protocol stack 810 can include protocol layers for a first wireless technology, while the second protocol stack 812 can include protocol layers for a second, different wireless technology. As examples, the first protocol stack 810 can operate according to the LTE technology, while the second protocol stack 812 can operate according to the ISM or GNSS technology.

In the foregoing example that includes an LTE protocol stack 810, the wireless access network node 822 can be an evolved node B (eNB) according to the LTE technology. An eNB can include functionalities of a base station and a radio network controller.

If the second protocol stack 812 operates according to the ISM technology, then the wireless access network node 826 in the wireless access network 828 can be a WiFi wireless access point, a Bluetooth master device, or some other type of wireless access point or base station. On the other hand, if the second protocol stack 812 operates according to the GNSS technology, then the wireless access network node 826 can be a satellite.

In the ensuing discussion, it is assumed that the first protocol stack 810 is an LTE protocol stack, and the wireless access network node 822 is an eNB. However, it is noted that techniques or mechanisms according to some implementations can be applied to other wireless technologies.

The LTE protocol stack 810 includes a physical layer 806 (that includes the radio interface 802) and higher layers 814 that include a medium access control (MAC) layer and upper layers. The physical layer 806 can be considered the lowest layer in the first protocol stack 810. The second protocol stack 812 includes a physical layer 808 (that includes the radio interface 804) and higher layers 816 that include a MAC layer and upper layers.

In accordance with some implementations, the radio interface 802, or another component in the physical layer 806, can derive the various feedback parameters relating to setting of an IDC interference threshold discussed above. These feedback parameters can be provided by the physical layer 806 to an upper layer 814 for transmission to the wireless access network node 822. In further implementations, the feedback parameters relating to setting of an IDC interference threshold can also be computed by the physical layer 808.

Generally, a MAC layer can provide addressing and channel access control mechanisms to allow the UE 800 to communicate over a shared medium, in this case a shared wireless medium. In some implementations, the upper layers of the LTE protocol stack 810 can include a Radio Resource Control (RRC) layer, as described in 3GPP Technical Specification (TS) TS 36.331. The upper layers can further include other protocol layers. The RRC protocol can define functionality associated with assignment, configuration, and release of radio resources between the UE 800 and the wireless access network node. Although reference is made to an RRC layer in the discussed examples, it is noted that in other examples, the upper layers can include alternative upper layers.

The upper layers that are included in the second protocol stack 812 depend on the wireless technology implemented by the second protocol stack 812.

As depicted in FIG. 8, the physical layer 806 further includes an interference detector 818. The interference detector 818 is able to detect IDC interference, such as IDC interference at a receiver of the radio interface 802 caused by transmission by a transmitter in the radio interface 804. In some examples, the interference detector 818 may also be able to detect IDC interference at a receiver of the radio interface 804 caused by transmission by a transmitter of the radio interface 802. In yet further examples, another interference detector (not shown) may also be provided in the physical layer 808 of the second protocol stack 812 to detect IDC interference at the receiver of the radio interface 804 caused by transmission by the transmitter of the radio interface 802.

Various techniques can be used for detecting IDC interference in a UE. Examples of several techniques are described in U.S. application Ser. No. 13/069,751, entitled “Method and Apparatus for Interference Identification on Configuration of LTE and BT,” filed Mar. 23, 2011.

In some examples, detection of IDC interference can be based on measurements at a radio receiver in the presence of transmissions from a radio transmitter. In alternative implementations, rather than performing detection of IDC interference based on measurements, IDC interference detection by the interference detector 818 can instead be based on internal coordination between the radio interfaces of the UE 800.

Upon detecting IDC interference and determining that the IDC interference satisfies one or more specified criteria (such as discussed above for uniform and non-uniform traffic patterns), the interference detector 818 can activate an interference notification 819 that is provided to an interference indication control module 820. The interference indication control module 820 can be provided in one of the higher layers 814. In alternative examples, the interference indication control module 820 can also be provided in the physical layer 806.

The interference indication control module 820 can respond to the interference notification 819 from the interference detector 818 by generating an IDC indication 821 that is to be transmitted from the UE 800 to a corresponding wireless access network node.

In this discussion, although reference is made to the LTE protocol stack 810 sending an IDC indication to the wireless access network node, it is noted that in other implementations, the second protocol stack 812 can also include a mechanism to detect IDC interference and to send an IDC indication to the corresponding wireless access network node 826. Moreover, although reference is made to specific indications, messages, and procedures that may be according to the LTE technology, it is noted that in alternative implementations, techniques or mechanisms as discussed can be applied also to other technologies for handling of IDC interference between radio interfaces of a UE.

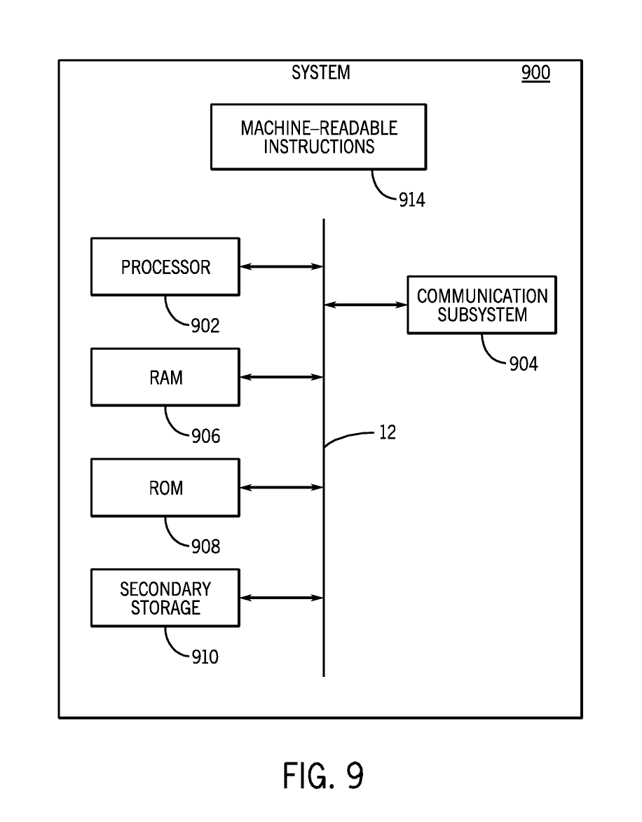

FIG. 9 illustrates an example system 900, which can either be the UE 800 or a wireless access network node, such as 822 or 826 in FIG. 8. The system 900 can include a processor (or multiple processors) 902. A processor can include a microprocessor, microcontroller, processor module or subsystem, programmable integrated circuit, programmable gate array, or another control or computing device.

The system 900 can include a communication subsystem 904 to communicate over a wireless link. The system 900 can also include various storage media, including a random access memory (RAM) 906 (e.g. dynamic RAM or static RAM), read-only memory (ROM) 908 (e.g. erasable and programmable read-only memory (EPROM), electrically erasable and programmable read-only memory (EEPROM), or flash memory), and secondary storage 910 (e.g. magnetic or optical disk-based storage), and so forth. The various components can communicate with each other over one or more buses 912.

Machine-readable instructions 914 in the system 900 are executable on the processor(s) 902 to perform various tasks discussed above, either in the UE 900 or in a wireless access network node. The machine-readable instructions 914 can be stored in any of the various storage media of the system 900.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
calculating, by a user equipment, a parameter based on a power of in-device coexistence (IDC) interference; and
sending, by the user equipment to a network node, the parameter for use in configuring a threshold relating to the IDC interference.

2. The method of claim 1, wherein calculating the parameter is triggered by the user equipment or the network node.

3. The method of claim 1, further comprising:
calculating, by the user equipment, a second, different parameter based on the power of IDC interference; and
sending, by the user equipment to the network node, the second parameter for use in configuring the threshold.

4. The method of claim 1, wherein calculating the parameter comprises calculating a parameter based on a ratio between the power of IDC interference and a desired signal power.

5. The method of claim 1, wherein calculating the parameter comprises calculating a differential parameter that is based on a signal to interference and noise ratio (SINR) without IDC interference and a ratio between the power of IDC interference and a desired signal power.

6. The method of claim 5, further comprising sending, by the user equipment to the wireless access network node, a difference between an SINR without IDC interference and an end value of a range of SINR values for a corresponding adaptive modulation and coding scheme,
wherein the difference is useable by the wireless access network node to determine the ratio between the power of IDC interference and the desired signal power.

7. The method of claim 5, wherein the differential parameter and an end value of a range of SINR values for a corresponding modulation and coding scheme are useable by the wireless access network node to determine the ratio between the power of IDC interference and the desired signal power.

8. The method of claim 1, wherein calculating the parameter comprises calculating a threshold based on a difference between an SINR with IDC interference and an SINR without IDC interference.

9. The method of claim 1, wherein calculating the parameter comprises calculating a threshold based on a difference between an SINR without IDC interference and a ratio between the power of the IDC interference and a desired signal power.

10. The method of claim 1, wherein calculating the parameter comprises calculating a parameter based on a ratio between the power of the IDC interference and an aggregate of neighbor cell interference power and noise power.

11. The method of claim 1, wherein calculating the parameter comprises calculating a first value of the parameter, and wherein sending the parameter is in response to the first value having a predefined relationship with respect to a feedback reporting threshold.

12. The method of claim 11, further comprising:
calculating a second value of the parameter;
determining that the second value of the parameter does not have the predefined relationship with respect to the feedback reporting threshold; and
sending an IDC indication in response to determining that the second value of the parameter does not have the predefined relationship with respect to the feedback reporting threshold.

13. A user equipment comprising:
a wireless interface configured to communicate with a wireless access network node; and
at least one processor configured to:
identify a traffic pattern from among a plurality of traffic patterns that cause in-device coexistence (IDC) interference; and
trigger transmission of an indication of IDC interference using a criterion selected from among different criteria for the corresponding traffic patterns.

14. The user equipment of claim 13, wherein the at least one processor is configured to trigger the transmission of the indication in response to the IDC interference being greater than a threshold for IDC interference mitigation, if the identified traffic pattern is uniform.

15. The user equipment of claim 14, wherein the at least one processor is configured to trigger the transmission of the indication at a beginning of the uniform traffic pattern.

16. The user equipment of claim 14, wherein the threshold is constant over a duration of the uniform traffic pattern.

17. The user equipment of claim 14, wherein the threshold is variable with respective modulation and coding schemes used by the user equipment.

18. The user equipment of claim 13, wherein the identified traffic pattern is a non-uniform traffic pattern, and wherein the at least one processor is configured to trigger the transmission of the indication in response to determining that an amount of time that the IDC interference is greater than a threshold for IDC interference mitigation exceeds a time duration threshold.

19. The user equipment of claim 18, wherein the time duration threshold is based on a configurable fraction parameter.

20. The user equipment of claim 19, wherein the time duration threshold is further based on a configurable reference time duration.

21. The user equipment of claim 20, wherein the fraction parameter and the reference time duration are configurable by the user equipment or the wireless access network node.

22. The user equipment of claim 13, wherein the transmission of the indication of IDC interference is based at least in part on determining that the IDC interference exceeds a threshold for IDC interference mitigation, and wherein the determining of whether the IDC interference exceeds the threshold is performed in time intervals that exclude time durations due to time selectivity of wireless channels.

23. A network node comprising:
a wireless interface configured to communicate with a user equipment; and
at least one processor configured to:
receive a feedback parameter from the user equipment, wherein the feedback parameter is based on a signal to interference and noise ratio (SINR) measurement;
derive a threshold for in-device coexistence (IDC) interference mitigation based on the feedback parameter; and
send the threshold to the user equipment.

24. The network node of claim 23, wherein the threshold is an exact threshold to be used by the user equipment.

25. The network node of claim 23, wherein the threshold is a threshold guideline useable by the user equipment to set a threshold to use.

26. The network node of claim 25, wherein the threshold guideline includes a range of thresholds.

27. The network node of claim 25, wherein the threshold guideline includes a collection of candidate thresholds.

28. The network node of claim 23, wherein the at least one processor is further configured to send a request to trigger derivation of the feedback parameter at the user equipment.
